(19) United States
(12) Patent Application Publication
(10) Pub. No.: US 2012/0191883 A1
(43) Pub. Date: Jul. 26, 2012

(54) INTERFACE INTEGRATED DEVICE AND ELECTRONIC DEVICE TESTING ARRANGEMENT

(75) Inventors: SHIH-FANG WONG, Tu-Cheng (TW); XIN LU, Shenzhen City (CN); FEI WANG, Shenzhen City (CN); BI-QING LUO, Shenzhen City (CN); HUI-FENG LIU, Shenzhen City (CN); JIA-HONG YANG, Shenzhen City (CN); PENG TANG, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/196,908

(22) Filed: Aug. 3, 2011

(30) Foreign Application Priority Data
Jan. 21, 2011 (CN) 201110023858.6

(51) Int. Cl. G06F 13/38

(52) U.S. Cl. 710/63

(57) ABSTRACT

An integrated interface device includes a conversion instruction receiving interface, an integrated input interface, an integrated output interface, and a conversion control module. The conversion instruction receiving interface is connected to a control device. The integrated input interface is connected to the control device, and integrates at least two interfaces. The integrated output interface is connected to an electronic device, and integrates at least two interfaces. The conversion control module receives a conversion instruction transmitted from the control device, and converts the integrated input interface and the integrated output interface to a designated interface according to the received conversion instruction.

### BACKGROUND

1. Technical Field

The present disclosure relates to an interconnect device, in particular, the interconnect device has a changeable input interface and a changeable output interface. The present disclosure also relates to an electronic device testing arrangement utilizing the interconnect device.

2. Description of Related Art

In manufacturing and testing of electronic devices, a control device can be used to control an electronic device under test to implement a desired distinctive function needed during the testing. For example, the control device may provide a single multipurpose interface to allow connection to the electronic device via cables to implement corresponding functions. In a specific example, the electronic device includes two separate interfaces: a Universal Serial Bus (USB) and a Universal Asynchronous Receiver and Transmitter (UART) interface. When burning a test program to the electronic device, the control device connects to the electronic device via a first cable extending from the multipurpose interface to the USB interface of the electronic device. After burning the testing program to the electronic device, the control device connects to the electronic device via a second cable extending from the multipurpose interface to the UART interface of the electronic device to test the electronic device. During such test process, the first cable running to the electronic device should be plugged into and later unplugged from the USB interface, and the second cable running to the electronic device should be plugged into and later unplugged from the UART interface. Thus, the repeated plugging and unplugging operations on the electronic device make it more likely that the interfaces thereof will sustain damage.

### BRIEF DESCRIPTION OF THE DRAWINGS

The components of the drawings are not necessarily drawn to scale, the emphasis instead being placed upon clearly illustrating the principles of the present disclosure.

FIG. 1 is a schematic diagram of an integrated interface device in accordance with an exemplary embodiment, showing the integrated interface device connected between a control device and an electronic device.

FIG. 2 is a flowchart for testing the electronic device by using the control device and the integrated interface device of FIG. 1, in accordance with an exemplary embodiment.

### DETAILED DESCRIPTION

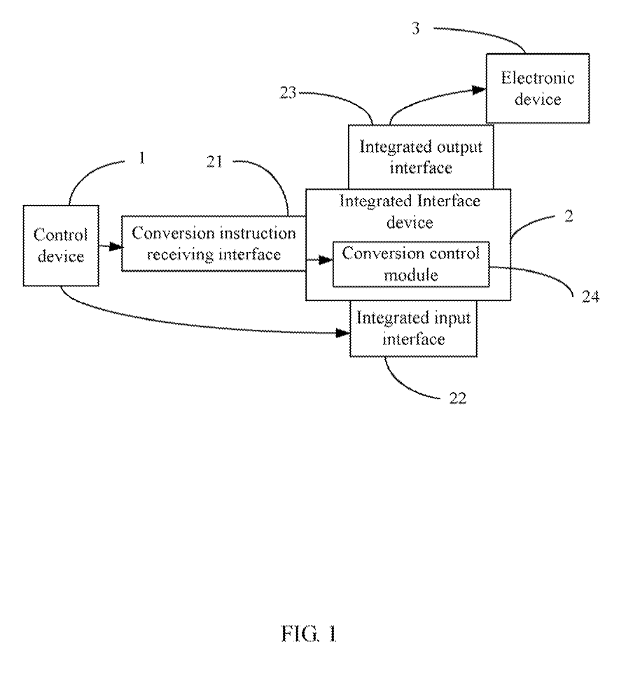

Referring to FIG. 1, a control device 1 is connected to an integrated interface device 2 in accordance with an exemplary embodiment. The integrated interface device 2 includes a conversion instruction receiving interface 21, a conversion control module 24, at least one integrated input interface 22, and at least one integrated output interface 23. The control device 1 is electronically connected to the integrated interface device 2 through both the conversion instruction receiving interface 21 and the integrated input interface 22. The integrated interface device 2 is electronically connected to an electronic device 3 through the integrated output interface 23.

In this embodiment, the connection from the control device 1 to the conversion instruction receiving interface 21 of the integrated interface device 2 is a wired connection such as a cable. The connection from the control device 1 to the integrated input interface 22 of the integrated interface device 2 is a wired connection such as a cable. In particular, the latter cable runs from a single multipurpose interface of the control device 1 to the integrated input interface 22.

In this embodiment, the electronic device 3 includes an integrated input interface (not labeled). The integrated input interface of the electronic device 3 can function as both a USB interface and a UART interface. The connection from the integrated output interface 23 of the integrated interface device 2 to the electronic device 3 is a wired connection such as a cable. In particular, the cable runs from the integrated output interface 23 of the integrated interface device 2 to the integrated input interface 22 of the electronic device 3.

Each of the integrated input interface 22 and the integrated output interface 23 of the integrated interface device 2 has at least two kinds of interfaces integrated together. In this exemplary embodiment, each of the integrated input interface 22 and the integrated output interface 23 has a USB interface and a UART interface integrated together.

Each of the integrated input interface 22 and the integrated output interface 23 includes a number of common pins among an array of pins. When each of the integrated input interface 22 and the integrated output interface 23 is used as a USB interface, the common pins are used as some of the pins of the USB interface. When each of the integrated input interface 22 and the integrated output interface 23 is used as a UART interface, the common pins are used as some of the pins of the UART interface.

The control device 1 transmits an interface conversion instruction to the integrated interface device 2 through the conversion instruction receiving interface 21. The conversion control module 24 receives the interface conversion instruction, and sets each of the integrated input interface 22 and the integrated output interface 23 to a designated interface according to the interface conversion instruction. For example, if the designated interface is a USB interface, the control device 1 sends a USB interface conversion instruction to the integrated interface device 2. The conversion control module 24 receives the USB interface conversion instruction, and enables all the pins corresponding to the USB interface in each of the integrated input interface 22 and the integrated output interface 23. Thereby, the integrated interface device 2 is used as a USB interface interconnection. If the designated interface is a UART interface, the control device 1 sends a UART interface conversion instruction to the integrated interface device 2. The conversion control module 24 receives the UART interface conversion instruction, and enables all the pins corresponding to the UART interface in each of the integrated input interface 22 and the integrated output interface 23. Thereby, the integrated interface device 2 is used as a UART interface interconnection.

In the following exemplary embodiment, the control device 1 and the integrated interface device 2 are used to test the electronic device 3. Generally, during testing the electronic device 3, the UART interface is used. However, before testing the electronic device 3, a testing program should firstly be burnt to the electronic device 3 through the USB interface.

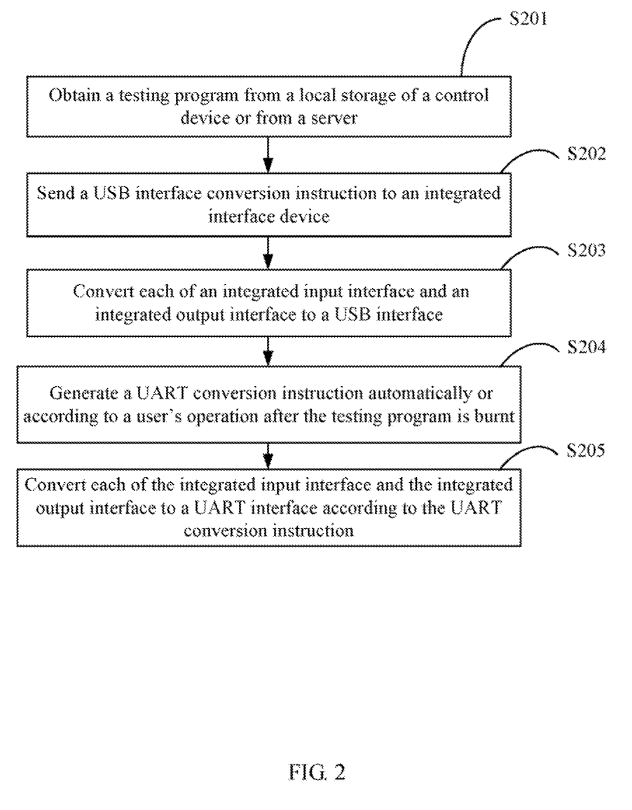

FIG. 2 is a flowchart of an exemplary method for testing the electronic device 3 by using the control device 1 and the integrated interface device 2. In step S201, the control device 1 obtains the testing program. The testing program can be obtained from a local storage (not shown) of the control device 1, or from a server (not shown).

In step S202, the control device 1 sends a USB interface conversion instruction to the integrated interface device 2 after the testing program is obtained.

In step S203, the conversion control module 24 of the integrated interface device 2 converts each of the integrated input interface 22 and the integrated output interface 23 to a USB interface.

After the testing program is burnt, in step S204, the control device 1 generates a UART conversion instruction automatically, or according to a user's operation.

In step S205, the conversion control module 24 of the integrated interface device 2 converts the integrated input interface 22 and the integrated output interface 23 to a UART interface according to the UART conversion instruction.

Although the present disclosure has been specifically described on the basis of preferred embodiments, the disclosure is not to be construed as being limited thereto. Various changes or modifications may be made to the embodiments without departing from the scope and spirit of the disclosure.

What is claimed is:

1. An integrated interface device comprising:
a conversion instruction receiving interface structured and arranged to be electronically connectable to a control device;
at least one integrated input interface, each of the at least one integrated input interface comprising at least two kinds of interfaces integrated together, and being structured and arranged to be electronically connectable to the control device;
at least one integrated output interface, each of the at least one integrated output interface comprising at least two kinds of interfaces integrated together, and being structured and arranged to be electronically connectable to an electronic device; and
a conversion control module configured for receiving a conversion instruction transmitted from the control device, and converting each of the at least one integrated input interface and the at least one integrated output interface to a designated kind of interface according to the received conversion instruction.

2. The integrated interface device as described in claim 1, wherein each of the at least one integrated input interface and the at least one integrated output interface comprises an array of pins, the array of pins corresponds to the at least two kinds of interfaces integrated together, and the conversion control module is configured to convert each of the at least one integrated input interface and the at least one integrated output interface to the designated kind of interface by enabling pins among the array of pins related to the designated kind of interface in each of the at least one integrated input interface and the at least one integrated output interface.

3. The integrated interface device as described in claim 2, wherein each of the integrated input interface and the integrated output interface includes a number of common pins among the array of pins, with the common pins related to all of the at least two kinds of interfaces.

4. The integrated interface device as described in claim 1, wherein the at least two kinds of interfaces of each of the at least one integrated input interface and the at least one integrated output interface comprise a Universal Serial Bus (USB) interface and a Universal Asynchronous Receiver and Transmitter (UART) interface.

5. The integrated interface device as described in claim 4, wherein the USB interface of each of the integrated input interface and the integrated output interface is capable of transmitting a testing program to be burnt to the electronic device.

6. The integrated interface device as described in claim 5, wherein the conversion control module is further configured for automatically converting each of the integrated input interface and the integrated output interface to the UART interface after the testing program is burnt to the electronic device.

7. An electronic device testing arrangement comprising:
a control device;
an integrated interface device; and
an electronic device to be tested;
wherein the integrated interface device comprises:
a conversion instruction receiving interface electronically connected to the control device;
an integrated input interface comprising at least two kinds of interfaces integrated together, and electronically connected to the control device;
an integrated output interface comprising at least two kinds of interfaces integrated together, and electronically connected to the electronic device; and
a conversion control module configured for receiving a conversion instruction transmitted from the control device, and converting each of the integrated input interface and the integrated output interface to a designated kind of interface according to the received conversion instruction.

8. The electronic device testing arrangement as described in claim 7, wherein the at least two kinds of interfaces of each of the integrated input interface and the integrated output interface comprise a Universal Serial Bus (USB) interface and a Universal Asynchronous Receiver and Transmitter (UART) interface.

9. The electronic device testing arrangement as described in claim 7, wherein each of the integrated input interface and the integrated output interface comprises an array of pins, the array of pins corresponds to the at least two kinds of interfaces integrated together, and the conversion control module is configured to convert each of the integrated input interface and the integrated output interface to the designated kind of interface by enabling pins among the array of pins related to the designated kind of interface in each of the integrated input interface and the integrated output interface.

10. The electronic device testing arrangement as described in claim 9, wherein each of the integrated input interface and the integrated output interface includes a number of common pins among the array of pins, with the common pins related to all of the at least two kinds of interfaces.
